(19) United States
(12) Patent Application Publication
(10) Pub. No.: US 2018/0161818 A1
(43) Pub. Date: Jun. 14, 2018

(54) VIBRATION GENERATOR USING PHASE DIFFERENCE FOR AMPLITUDE CONTROL AND METHOD THEREOF

(71) Applicants: Byung Man Kwak, Seongnam-si (KR); Joon Young Kwak, Portland, OR (US); Kyung Woon Kwak, Daejeon (KR)

(72) Inventors: Byung Man Kwak, Seongnam-si (KR); Joon Young Kwak, Portland, OR (US); Kyung Woon Kwak, Daejeon (KR)

(21) Appl. No.: 15/106,297

(22) PCT Filed: Jan. 29, 2015
(86) PCT No.: PCT/KR2015/000987

§ 371 Date: Jun. 20, 2016

(30) Foreign Application Priority Data
Feb. 24, 2014 (KR) 10-2014-0021058

(51) Int. Cl. B06B 1/16; F16F 15/20; G05D 19/02; H02K 7/06; H02K 7/065

(52) U.S. Cl. CPC B06B 1/166; F16F 15/20; H02K 7/065; H02K 7/061; G05D 19/02

(57) ABSTRACT

Most vibration generators that use rotating eccentric masses of prior arts have disadvantages in controlling vibration magnitude such as stopping equipment, adjusting intermittently, or limitation on control range. In the present invention to continuously change the direction of a generated vibration force or its magnitude, the principle of synthesizing simple harmonic motions by phase shifting is used and two methods, called a mechanical phase shifting and a motor speed controlled phase shifting, are provided. A mechanical phase shifting device includes an angle adjusting plate to change the phases of two eccentric mass rotators and two pairs of gears and links for a reverse rotation of eccentric masses. A motor speed controlled phase shifting is enabled by acceleration and deceleration of a motor. A moment generator comprises two sets of eccentric mass vibrators connected by extending shafts between them and can be used for industry shakers, stabilizer's for floating bodies, and so on.

### CROSS-REFERENCE TO RELATED APPLICATIONS

This application is related to the international application as follows:
Application number: PCT/KR2015/000987
Filing date: Jan. 29, 2015
Priority date: Feb. 24, 2014 (10-2014-0021058 KR)

This specification is a translation of said international application from Korean, which is accurate to the best of the applicant's knowledge.

References searched by the examiner of said international application are:
Publication number: JP201300053513A0P, Mar. 21, 2013, BOMAG GMBH
Publication number: JP199700187729A0P, Jul. 22, 1997, Moog Inc.
Publication number: JP02096064A, Apr. 6, 1990, and
PCT number: PCT/DE99/01348 (WO99/58258, Nov. 18, 1999), Hubert BALD, et.al.

### BACKGROUND OF THE INVENTION

The present invention relates to a vibration generator to excite an object, utilizing rotating eccentric masses, and to an oscillation reducer to suppress oscillation of an object, for example, a floating body which is in motion or moored on the sea.

Vibrators (oscillator, exciter or shaker) that utilize rotating eccentric masses are in use in various application areas. In most prior arts, however, to adjust the amplitude of a generated vibration force, the amount of eccentric mass or the length of an eccentricity arm is adjusted off-line while stopping the equipment, although the frequency can be changed simply by adjusting the speed of a driving motor. Therefore this type of intermittent adjustment of amplitude is not appropriate to many applications where a real-time continuous control is required.

For stabilization of a floating body, the moment generated by vibrators of two sets of eccentric masses that are separated by a distance and rotate with a phase difference of 180 degrees can be utilized to oppose exciting moments, but in prior arts it has limitations in controlling the amplitude in real-time from zero to a designed maximum.

### BRIEF SUMMARY OF THE INVENTION.

The object of the present invention is to provide methods of a real-time, continuous control of the amplitude in addition to the frequency of generated vibration forces and corresponding equipment thereof, either to vibrate an object or to reduce oscillations such as roll of a floating body.

In order to achieve the objective, a method in accordance with the present invention is to adjust the phases of two eccentric mass rotators so that the resultant vibration force of the two rotators changes its direction or its magnitude from zero to a designed maximum continuously in real-time. Therefore a vibration generator in the present invention comprises two sets of eccentric mass rotators, a frame to install said two sets of rotators, another frame for power transmitting elements such as pulleys and gears that make the masses rotate in opposite direction, a set of gears and links connecting the two frames, and an angle adjusting plate to control the relative slope of the two frames. By combining two or more vibration generators, other embodiments such as a vertical direction vibration exciter and a stabilizer for a floating body are illustrated.

### BRIEF DESCRIPTION OF THE DRAWINGS

FIG. 1 is a schematic diagram for a synthesis of two simple harmonic motions;

FIG. 2 is layouts of four kinematic constructions for a mechanical phase shifting;

FIG. 3 is a plan view and side view of a mechanical phase shifting vibration generator;

FIG. 4 is an illustrative graph for a motor speed controlled phase shifting using acceleration and deceleration of a motor;

FIG. 5 is a block diagram of a vibration generator using a motor speed controlled phase shifting;

FIG. 6 is a plan view of a phase controlled moment generator; and

FIG. 7 is a schematic diagram of a floating body stabilizer and a typical arrangement for control of rolling and pitching.

### DETAILED DESCRIPTION OF THE INVENTION

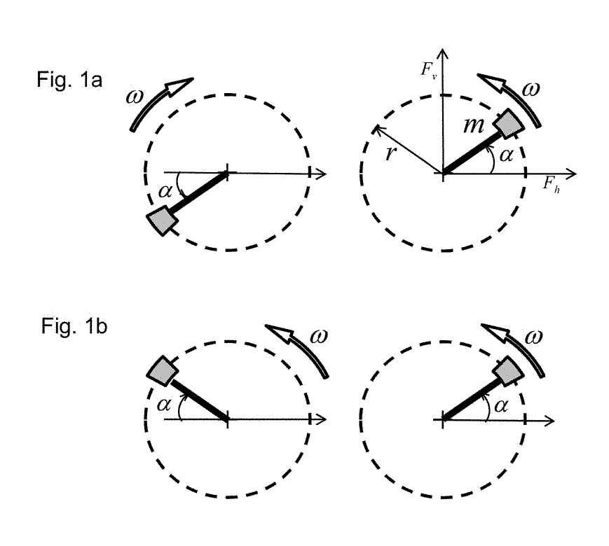

To illustrate an effect of a phase shifting in the present invention necessary for a continuous real-time control of amplitude of a generated vibration force, the synthesis of simple harmonic motions of two uniformly rotating eccentric masses having different phases is introduced and corresponding formulas of resulting vibration forces are summarized. Referring to the eccentric mass of the right hand side in FIG. 1a, the vertical component of the force induced by an eccentric mass, m, located at a radial distance, r, from the center of the shaft and rotating with an angular velocity, ω, can be obtained as,

Fᵥ₁=mrω² sinωt−mg.

The horizontal component is

Fₕ₁=mrω² cosωt.

If a second eccentric mass is arranged in parallel as a mirror image of the first one and rotated in the opposite direction as shown in FIG. 1a, the, resultant induced force of the two rotating eccentric masses is given by,

Fᵥ=2(mrω² sinωt−mg).

and the horizontal component is,

Fₕ=0.

This means that the mean of the force induced on the two shafts is 2 mg, and a periodic force with amplitude of 2 mrω² is induced on the shafts. This force will brate a frame on which the two shafts are installed.

To enable control of the amplitude of a generated vibration force, the synthesis of vibration forces under a phase shifting is used in the present invention. Referring to the right hand eccentric mass of FIG. 1a which rotates at ω if the phase of this mass is advanced by α, the vertical component of the induced force is given by,

F_{v1α}=mrω² sin(ωt+α)−mg.

If the phase of the left hand mass which also rotates at ω in the opposite direction is shifted by α backward, the vertical component of the force is,

F_{v2α}=mrω² sin(ωt−α)−mg.

The vertical component of the resultant induced force is given by,

F_{vα}=2(mrω² cos α sin ωt−mg).

The magnitude of the resultant vertical component is 2 mrω² cosα and hence when α=0, a maximum magnitude of 2 mrω² is obtained and when α=±90°, the amplitude becomes zero. By adjusting the phase α, the amplitude of the vertical component can be controlled. The horizontal component of the resultant force is given by,

F_{hα}=−2mrω² sin α sin ωt.

The resultant vibration force vector with a phase α is now summarized as,

$$Magnitude : F = 2 mr {ω}^{2} sin ω t$$

$$and Angle : ( \frac{π}{2} - α ) .$$

This shows that the vector of the resultant vibration force is directable by changing α, and may be called as a directable vibration force vector. When α=0, the vibration force is acting along the vertical direction and when α=45°, the force is acting along a direction that makes 45° from the horizontal line.

When there are two eccentric masses, depending on the direction of rotations and direction of the phase shifting, four operating modes are possible: referring to the second eccentric mass, mode (1) reverse rotation direction and forward phase shifting, mode (2) reverse rotation direction and backward phase shifting, mode (3) forward rotation direction and forward phase shifting, and mode (4) forward rotation and reverse phase shifting. Here the forward phase shifting means shifting the phase counterclockwise. The formulas derived above for FIG. 1 a corresponds to mode (1). Mode (4) is shown in FIG. 1b and the induced forces are similar to that of mode (1). In this mode, the vertical component of the vibration force is, 2(mrω² sin α cos ωt−mg), that is cos ωt appears instead of sin ωt.

It may be possible to assign different amounts of phase shifting to the first eccentric mass and the second, but it is not much of use. Also a third eccentric mass may be added or different size eccentric masses may be considered, but it can be too complex to control or to make use of them.

Two methods and corresponding embodiments of realizing the principle of vibration force synthesis by a phase shifting in accordance with the present invention are devised and described below. The first one is a mechanical phase shifting and the second a motor speed controlled phase shifting.

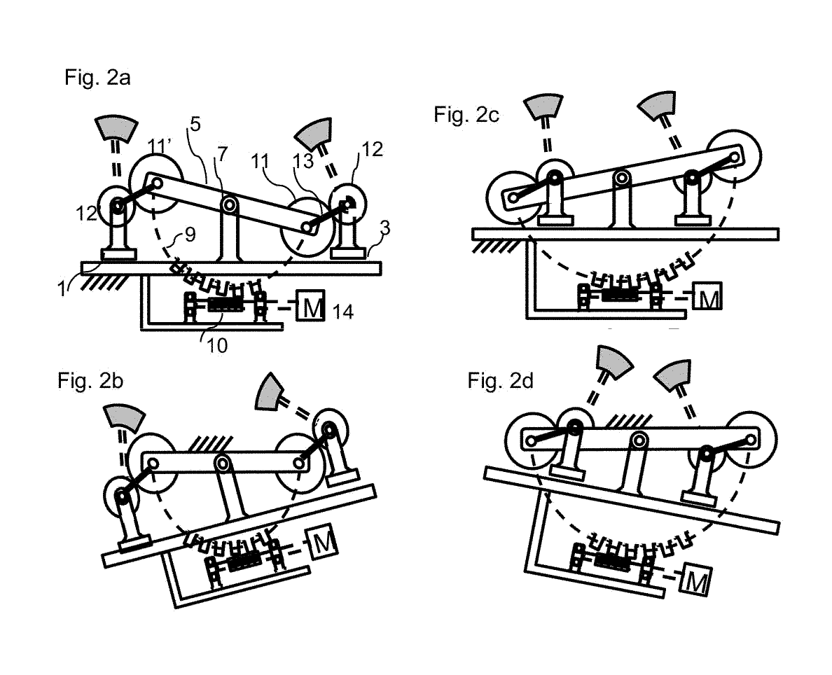

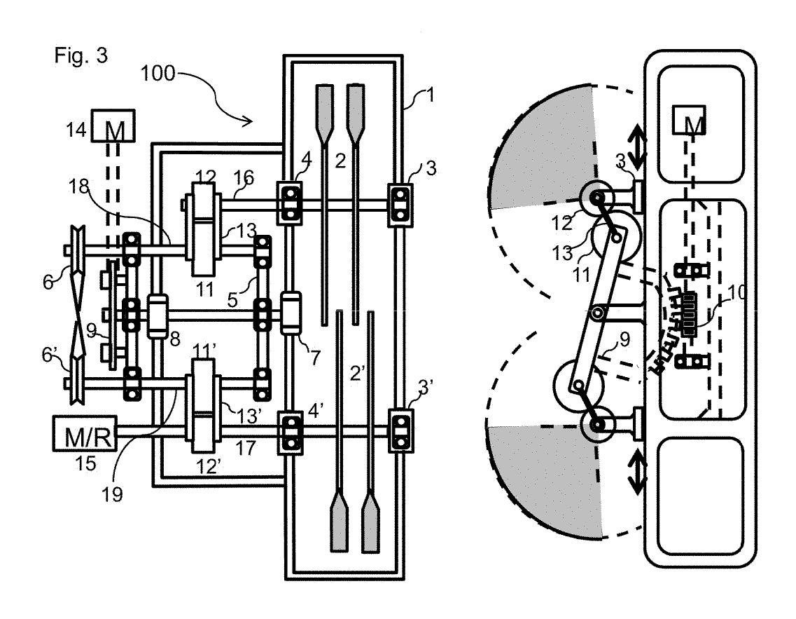

The first method is illustrated using a mechanism in FIG. 2a, which represents a situation shown in FIG. 1a. One of its embodiments is illustrated in FIG. 3. A reverse rotation shaft frame 5 has bearings supporting two shafts 18 and 19 on which gears 11 and 11′ are installed, and pulleys 6 and 6′ which are cross-connected by a belt are installed. The frame 5 is mounted on a main frame 1 through pivots 7 and 8. The frame 5 also has a worm wheel 9, which is called an angle adjusting plate 9, by which the sloping angle of the frame 5 can be adjusted. If the angle adjusting plate 9 is turned by an angle β clockwise, then a gear 12 installed on the shaft 16 of an eccentric mass 2 is turned counterclockwise by an angle, α=[(1+r₁₁/r₁₂)α₁−β] that is, a forward phase shifting of a is obtained. Likewise agear 12′ has a forward phase shifting of α. Here r₁₁ and r₁₂ denote the radii of gears 11 and 12, respectively and α₁ is the angle between a link 13 and the line connecting the centers of the gears 11 and 11′. From a geometric condition, the sloping angle β can be expressed in terms of a phase shifting angle α. The worm gear 10 matches the worm wheel 9, identical to the angle adjusting plate 9. Actuating the worm gear 10 by an actuating motor 14, the phase angle α is controlled as desired continuously in real-time. For the case shown in FIG. 1b, where the left rotating mass is rotating forward, to make a backward phase shifting, it is necessary to have two separate links, that is, a link connecting the pivot 7 and the gear 11 and another link between the pivot 7 and the gear 11′ such that they can be rotated in opposite directions each other. A similar two link system is necessary to have a backward phase shifting for mode (2). This embodiment is not illustrated as a figure.

FIG. 2 shows schematic layouts of mechanical phase shifting mechanisms of the present invention. Four layouts in FIGS. 2a, 2b, 2c, and 2d are possible depending on whether gears 12 and 12′ are placed inside or outside of the reverse rotation gears 11 and 11′ and whether which of the gear systems is fixed to the main frame 1, which is shown hatched in the figure. A selection from these four alternatives can be made considering specific applications. In driving the two sets of eccentric mass rotators, only one driving motor such as a driving motor/reducer 15 in FIG. 3 can be used and hence the rotations of the eccentric masses are well synchronized. The frequency of vibrating forces is controlled by the driving motor/reducer 15 and its amplitude by the actuating motor 14 and thus a real-time continuous control of both the amplitude and frequency is provided.

FIG. 3 shows an embodiment of a phase controlled vibration generator 100 based on the mechanical phase shifting mechanism of FIG. 2a. The vibration generator 100 has an eccentric rotator system composed of an eccentric mass rotator 2 with one or a plurality of eccentric masses and a gear 12 fixed on the shaft 16 of said rotator, and a second eccentric rotator system composed of an eccentric mass rotator 2′ with the same type and number of eccentric masses as the eccentric mass rotator 2 and a gear 12′ fixed on the shaft 17 of the second eccentric mass rotator. The two eccentric rotator systems are supported on the main frame 1 through a set of linear guides 3 and 4 and another set of linear guides 3′ and 4′, respectively.

An eccentric mass may be designed as a module in any convenient shape such as a disc or a cylinder, part of which is removed. To meet a capacity requirement, a plurality of modules of such eccentric masses may be assembled. A driving motor/reducer 15 may drive either the shaft 16 of the first rotator system or the shaft 17 of the second rotator system for convenience. The motor/reducer 15 may even be installed to the shaft 18 or 19. The motor/reducer 15 must be supported on a frame where the corresponding driven shaft is supported. In the case of FIG. 3, the motor/reducer 15 must be mounted on the main frame 1 through a linear guide similar to the linear guide 3′ or 4′, but the linear guide for the motor is not illustrated in FIG. 3.

Transmission of shaft power with a reverse rotation is done by a shaft 18 with a pulley 6 and a gear 11 and another shaft 19 with a pulley 6′ and a gear 11′. The frame 5 supports the two shafts 18 and 19 and is pivoted with pivots 7 and 8 that are installed on the main frame 1. Pulleys 6 and 6′ are connected by belts crossed for reverse rotation. A pulley for power transmission is only one example and a gear system may be arranged with the same effect. Likewise for modes (3) and (4) where the two eccentric rotator systems rotate in the same direction, a pulley system or a gear system can be similarly arranged.

To make a phase shifting, an angle adjusting plate 9 is installed on the frame 5. The angle adjusting plate 9 that is also a worm wheel, matches a worm gear 10 which is actuated by an actuating motor 14. Instead of said worm wheel and worm gear illustrated, a mechanism of changing an angular motion to a translation motion with a translation actuator or an angle actuator can be used with the same purpose of angle adjustment.

The functioning of an embodiment illustrated in FIG. 3 by the first method of a mechanical phase shifting in accordance with the present invention is described below. When the driving motor/reducer 15 rotates, the eccentric mass rotator 2′ and the gear 12′ are rotated and accordingly the gear 11′ rotated. When the pulley 6 crossed belted to the pulley 6′ is rotated, the gears 11 and 12 are rotated and accordingly the eccentric mass rotator 2 is rotated in the opposite direction to the eccentric mass rotator 2′. The centripetal forces of the two eccentric mass rotators 2 and 2′ are acted on the main frame 1 as vibration forces. The main frame 1 then transmits the vibration forces to an object to be vibrated that is fixed to the main frame 1. Such an object is not illustrated in FIG. 3. The frequency of a vibration force can be controlled by speed control of the motor/reducer 15. Hence an amplitude control of the generated vibration force is described in accordance with the present invention. If the actuating motor 14 rotates, the angle adjusting plate 9 together with the frame 5 is rotated through the worm wheel and worm gear 10. The gear 12 is rotated like a planetary gear around the gear 11 as a sun gear. In mode (1) corresponding to FIG. 2a, the amount of rotation of the gear 12 becomes the phase shifting of the eccentric mass rotator 2, and similarly the phase of the eccentric mass rotator 2′ is also shifted by the same amount, both in the same direction. According to the formula of vibration synthesis with a phase shifting, the amplitude or the magnitude of the resultant vibration force is controlled by α, that is, by the angle change of the angle adjusting plate 9. Since the angle adjustment can be made continuously in real-time by the actuating motor 14, the direction of the generated vibration force is also controlled continuously in real-time. Since the gear 12 and the gear 12′ are pulled or pushed when the angle adjusting plate 9 together with the frame 5 is inclined, the shafts of the gears 12 and 12′, and so the eccentric mass rotators 2 and 2′ must be supported by translation guides such as linear guides 3 and 4, and linear guides 3′ and 4′ illustrated in FIG. 3. Other types of translation guide such as a lead screw or a ball screw can do a similar role, in this case as an actuating element, instead of the worm wheel and worm gear 10. This alternative is not illustrated as a figure. A similar description for the mechanisms of FIGS. 2b, 2c and 2d is also possible but omitted.

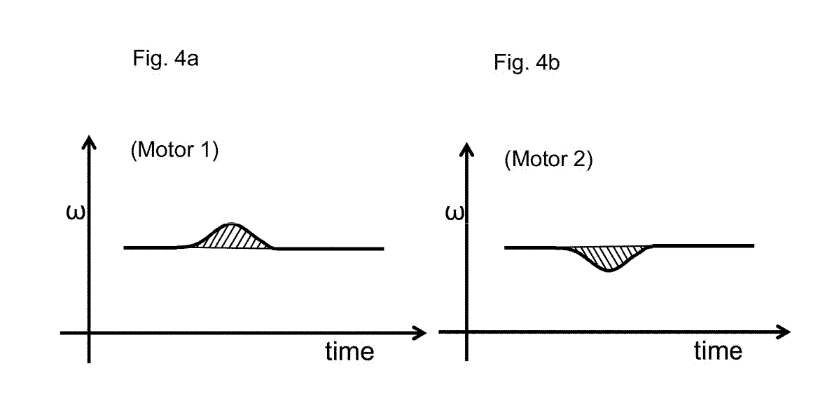

A second method of enabling a phase shifting to be called a motor speed controlled phase shifting in the present invention is to use direct control of a motor and is graphically described in FIG. 4. Instead of using one driving motor for two eccentric mass rotators in the mechanical phase shifting mechanism by the first method, each eccentric mass rotator in the second method is driven by a separate driving motor and this driving motor controls the phase of the corresponding rotator. As shown in FIG. 4a, if the speed of a motor is increased for certain time and then decreased to resume the original speed, the phase of the shaft of the motor is advanced by an angular displacement corresponding to the amount of the hatched area in the figure. Likewise if a speed is decreased and then increased as illustrated in FIG. 4b, a backward phase shifting is obtained. A similar effect of a forward and backward shifting can be obtained even when the running speed of a motor is varying.

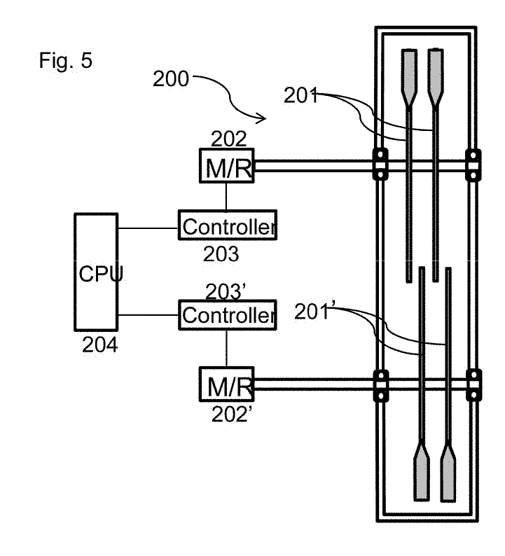

FIG. 5 shows a block diagram of an embodiment of a vibration generator 200 according to a motor speed controlled phase shifting of the present invention. Motor/reducers 202 and 202′ are installed respectively to each shaft of the eccentric mass rotators 201 and 201′, and these motors are controlled by controllers 203 and 203′, which are in turn commanded by a logic processor, CPU 204. The logic processor generates appropriate function shapes of acceleration and deceleration as illustrated in FIGS. 4a and 4b and sends them to the controllers 203 and 203′ to provide a required phase shifting.

For a vibration generator that uses rotating eccentric masses, to facilitate control of the direction of a generated vibration force continuously in real-time, it has been provided a synthesis principle of mechanical simple harmonic motions and corresponding methods thereof. This enables precise control of the vertical and horizontal component of a vibration force and opens new applications not possible in prior arts. For example without even physically orienting a vibration generator, it is possible to orient the direction of a generated vibration force, and this feature can be utilized to new applications.

Furthermore a moment generator is obtained by extending the shafts of the eccentric mass rotators of a vibration generator of the present invention and installing another set of eccentric mass rotators at the extended ends with a phase difference of 180 degrees. Also a floating body stabilizer can be composed by arranging a second moment generator in parallel as a mirror image. Since the two extended shafts of the eccentric mass rotators in a moment generator are weight balanced individually, almost no power is required unless when accelerated or decelerated and thus the system operation can be economical. A vibration generator and a moment generator by either of the two methods of phase shifting in the present invention can be controlled to have zero vibration force and moment as if they are in standstill even when running. Hence in applications where frequent running and stopping is required, any additional power that would be needed for restarting in prior arts is saved.

In the following, various embodiments including a moment generator and a floating body stabilizer are described. They are obtained by combining mechanical phase controlled vibration generators 100 of FIG. 3 or motor speed controlled phase shifting vibration generators 200 of FIG. 5. A characteristic of a vibration generator in the present invention is: if phase α is zero, the amplitude of the vertical component of a vibration force becomes a maximum while the horizontal component is zero. For an arbitrary phase α, there occur both vertical and horizontal vibration forces. The magnitude of the resultant vibration forces is always the same. That is, if the phase α is changed from zero to ±90° the corresponding vibration force vector changes its direction from vertical to horizontal and the vector appears as a directable vibration force vector. Without physically rotating a vibration generator, the generated forces can be rotated. This feature may be made use of in a massager or vibrator, where a variable direction of vibration forces is desirable. A new design such as a shale shaker of a drilling fluid processor in an oil drilling can be provided effectively using this feature. Especially when only one specific direction of vibration is required as in the case of a shale shaker, two rotating eccentric masses may be preset at a phase difference necessary for the required direction of vibration, without installing a general phase control device.

If however there should be no horizontal component, by arranging another vibration generator in parallel with the first one but operating it as a mirror image of the first one, the horizontal component can be cancelled. In this case when the phase α is set at ±90° both the vertical and the horizontal component of the resultant vibration force are zero, that is, even though the vibration generators are running, no forces induced at all as if they are in standstill. Some operations such as making concrete blocks require much power, when running a vibrator for a vibration work and stopping it for feeding sand and cement are repetitive. For a vibration generator in accordance with the present invention, no stopping is necessary and so it requires less power. It is also noted that one motor/reducer can be used commonly for driving both the vibration generators arranged in parallel using for example pulleys and chains.

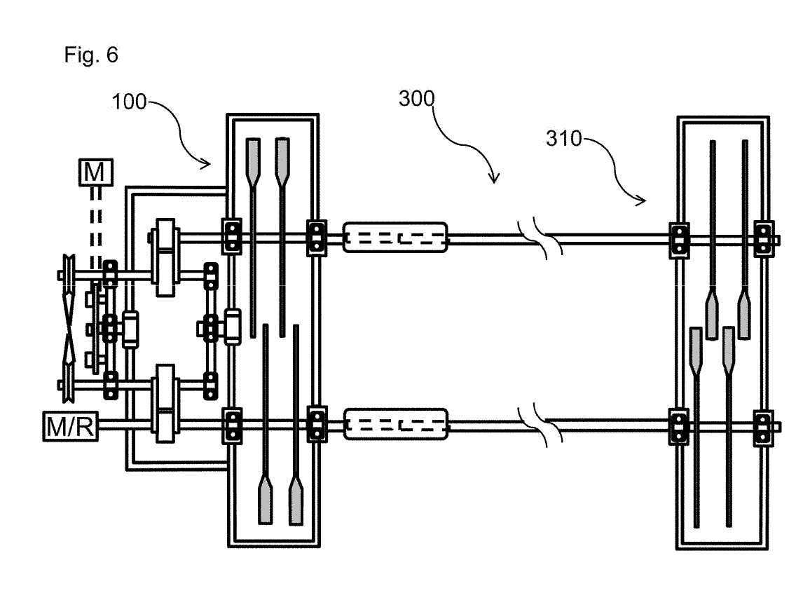

FIG. 6 shows an illustrative embodiment of a moment generator 300 using a vibration generator 100. Shafts 16 and 17 of the eccentric mass rotators in a vibration generator 100 in FIG. 3 are extended to be coupled with the shafts of a second unit of eccentric mass rotators 310. Eccentric masses in said second unit are installed with a phase difference of 180 degrees from those in the eccentric mass rotators of the vibration generator 100. Extension of shafts of the rotators can be selected from either end of the rotators for convenience. The extended shafts may be connected to the eccentric mass rotators with flexible couplings and/or some connecting elements such as a universal joint or power transmission elements such as gears. This kind of compositions combining with second eccentric mass rotators also applies to the motor speed controlled phase shifting vibration generator 200 in FIG. 5. In a moment generator 300 in FIG. 6, two eccentric masses are attached on a shaft with diametrically opposite sides and hence weight balanced. This means very desirable advantages of less driving torque and long life of parts such as bearings. In this composition, two eccentric mass rotators 100 and 310 generate vibration forces in opposite directions each other, which generate a moment. The maximum amplitude of the moment generated is given as 2 mrω² L where L is the distance of the two eccentric mass rotators of the vibration generator 100 and 310. If each of the eccentric mass rotators of a moment generator is installed on a separate body, each appears as a vibration generator.

If there is only one moment generator 300 of FIG. 6, a non-zero vertical component of the generated moment vector is also accompanied when phase a is not zero. If a phase α is changed from zero to ±90 degrees, the vector of a generated moment, changes its direction from vertical to horizontal; that is, it is a directable vibration moment vector. This feature can be made useful in different applications such as a body vibrator, oscillator and shaker.

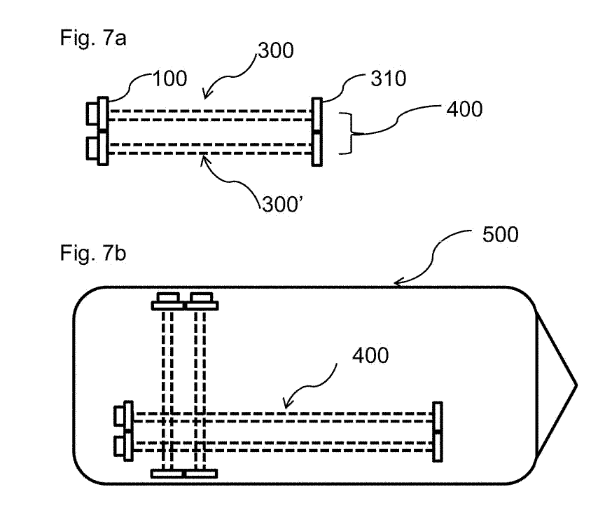

Further utilization of a vibration moment generator 300 is illustrated in FIG. 7 as a floating body stabilizer 400. In FIG. 7a, to cancel the vertical component of a generated moment vector, a second vibration moment generator 300′ identical to the vibration moment generator 300 is placed in parallel with the vibration moment generator 300 but with reversed rotations. An ocean floating body, which is usually excited relatively periodically by wave and/or wind, can be stabilized against a rolling oscillation by applying a vibration moment opposing the rolling oscillation. The moment, generated by a moment generator of the present invention is linearly proportional to the distance between the two eccentric mass rotators, and therefore it is necessary to maximize the distance as far as possible within a given space. Since in between the two eccentric mass rotators are shafts only, a convenient shaft arrangement can be made to minimize dead space. Another advantage is that it is possible to make vibration moment zero by adjusting the phase a without even stopping the machine. This feature is well suitable for stabilizing moored floating bodies such as a floating house and an ocean plant.

A floating body 500 as shown in FIG. 7b experiences rolling and pitching oscillations although usually rolling is much dominant. To suppress both rolling and pitching, two sets of stabilizers 400 may be arranged perpendicularly each other as illustrated in FIG. 7b. A floating body stabilizer 400 is operated and controlled against forced oscillations from wave, etc. by sensing for example the inclination of the floating body and the times when the eccentric masses pass a pre-determined position such as an up-position. A stabilizer in accordance with the present invention is unique and has advantages in terms of power requirement, space requirement, noise, mechanical simplicity, control precision and cost, compared to prior arts such as an anti-rolling tank, a gyrostabilizer or a fin stabilizer.

Although specific ways and means for practicing the present invention for vibration generation, moment generation or stabilization have been described herein and illustrated in the accompanying drawings, they are only for purposes of illustration and the scope of the invention is not limited thereby but is to be determined from the appended claims. Further, since numerous modifications and variations will, readily occur to those skilled in the art, it is not desired to limit the invention to the exact construction and operation illustrated and described, and, accordingly, all suitable modifications and equivalents may be resorted to that fall within the scope of the invention.

The invention claimed is:

1. A phase controlled vibration generator, comprising:
two eccentric mass rotators, each having a plurality of eccentric masses and rotating in opposite direction;
a phase adjusting device for shifting the phases of said two eccentric mass rotators forward or backward;
a driving motor/reducer for said two eccentric mass rotators;
an actuating motor for said phase adjusting device; and
a logic processor and controllers for said driving motor/reducer and said actuating motor.

2. A phase controlled vibration generator of claim 1, wherein the phases of said two eccentric mass rotators are controlled either forward and backward or forward and forward such that the direction of a synthesized vibration force of two simple harmonic circular motions of said two eccentric mass rotators is adjustable.

3. A phase controlled vibration generator of claim 1, wherein said phase adjusting device comprising;
a frame having two shafts and two links connected by bearings;
a reverse rotation unit for the two shafts on which two gears are installed transmitting power to the shafts of rotating eccentric masses, respectively; and
an angle adjusting plate fixed on a link of said frame.

4. A phase controlled vibration generator of claim 1, wherein said phase adjusting device comprising:
two driving motor/reducers connected respectively to two eccentric mass rotators; and
a logic processor and two controllers for changing each of the phases of the shafts of said two driving motor/reducers forward or backward by using acceleration and deceleration of said shafts.

5. A phase controlled vibration generator which vibrates along a vertical direction comprising:
two sets of phase controlled vibration generators of claim 1 arranged in parallel as a mirror image each other.

6. A phase controlled moment generator comprising:
a phase controlled vibration generator of claim 1, whose shafts are extended to connect two additional eccentric mass rotators of the same structure as the rotators of said phase controlled vibration generator with a phase difference of 180 degrees between a pair of eccentric mass rotators that are installed at both ends of each extended shaft.

7. A phase controlled floating body stabilizer comprising:
two sets of phase controlled moment generators of claim 6 that are arranged in parallel as a mirror image each other, such that the vertical component of the moment generated from each phase controlled moment generator is cancelled.

8. A phase adjusting device of claim 3 comprising:
an angle adjusting plate;
a worm and worm gear connected to said angle adjusting plate;
an actuating motor for said worm and worm gear; and
a controller for said actuating motor.
